(19) United States
(12) Patent Application Publication
(10) Pub. No.: US 2013/0041985 A1
(43) Pub. Date: Feb. 14, 2013

(54) TOKEN BASED FILE OPERATIONS

(71) Applicants: Neal R. Christiansen, Bellevue, WA (US); Dustin L. Green, Redmond, WA (US); James T. Pinkerton, Sammamish, WA (US); Rajeev Nagar, Sammamish, WA (US); Bryan Stephen Matthew, Bothell, WA (US); Jaivir K. Aithal, Bellevue, WA (US)

(72) Inventors: Neal R. Christiansen, Bellevue, WA (US); Dustin L. Green, Redmond, WA (US); James T. Pinkerton, Sammamish, WA (US); Rajeev Nagar, Sammamish, WA (US); Bryan Stephen Matthew, Bothell, WA (US); Jaivir K. Aithal, Bellevue, WA (US)

(73) Assignee: Microsoft Corporation, Redmond, WA (US)

(21) Appl. No.: 13/207,014

(22) Filed: Aug. 10, 2011

(51) Int. Cl. G06F 15/16; G06F 17/30

(52) U.S. Cl. 709/219

(57) ABSTRACT

Described are embodiments which allow token-based file operations. The client may request a special offload file operation that is formatted according to a file access protocol. The file operation may be an offload read operation or an offload write operation. In an offload read operation, the client requests that data be logically read from a stored file, or a portion thereof. In response, the file server provides a response that includes a token that represents the logically read data. In some embodiments, the file server may return a response with a token that represents less than all of the requested data if for some reason it cannot provide a token that represents all of the data. The token can then be used by the client in a subsequent offload write operation. In embodiments, the tokens represent immutable data that can be safely and securely used across servers and clients.

### BACKGROUND

In traditional ways of copying large amounts of data, data is read into local RAM from a source file, and then the same bytes are written from RAM back to a destination file. This process requires the data to travel a route that includes local RAM, even though completion of the copy does not inherently require the data to ever be in local RAM. When there is a trusted faster route that the data could take between ultimate source and ultimate destination, the detour through local RAM is unnecessary. This problem is more acute when the difference in speed is large between the trusted faster route vs. the route via local RAM. Currently, some file servers, such as Server Message Block (SMB) file servers, allow a client to copy ranges of a source file to ranges of a destination file. However, there are a number of limitations such as limits on copying data among files open on the same file server. Also, SMB file servers only allow the client to issue a single command which specifies both the source and destination ranges. Often client code structure will be set up to use read and write separately to achieve a copy, which is not consistent with the current way SMB file servers provide for copying ranges of data.

It is with respect to these and other considerations that embodiments have been made. Also, although relatively specific problems have been discussed, it should be understood that the embodiments should not be limited to solving the specific problems identified in the background.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Described are embodiments which allow token-based file operations. The embodiments provide for a client to establish a session with a file server. The session may be established using any file access protocol, one example including the Server Message Block (SMB) protocol. After the session is established, the client may request a special offload file operation that is formatted according to the file access protocol. The file operation may be a read operation or a write operation. In an offload read operation, the client requests that file data be read from a file stored in a file storage system accessible to the file server. In return, the file server will provide a response that includes a token that represents the file data. In some embodiments, the file server may return a response with a token that represents less than all of the file data if for some reason it cannot provide a token that represents all of the file data. The token can then be used by the client in a subsequent offload write operation, or other related operations (e.g., subsequently obtaining the data represented by the token should that become necessary). In embodiments, the tokens represent immutable data that can be safely and securely used across servers and clients.

Embodiments may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures.

FIG. 1 illustrates a system that may be used to implement embodiments.

FIG. 2 illustrates a block diagram of clients and servers engaged in token based file operations using a file access protocol consistent with some embodiments.

FIG. 3 illustrates an operational flow for processing offload file operations consistent with some embodiments.

FIG. 4 illustrates an operational flow for processing an offload read request consistent with some embodiments.

FIG. 5 illustrates an operational flow for processing an offload write request consistent with some embodiments.

FIG. 6 illustrates an operational flow for requesting offload file operations consistent with some embodiments.

FIG. 7 illustrates a block diagram of a computing environment suitable for implementing embodiments.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

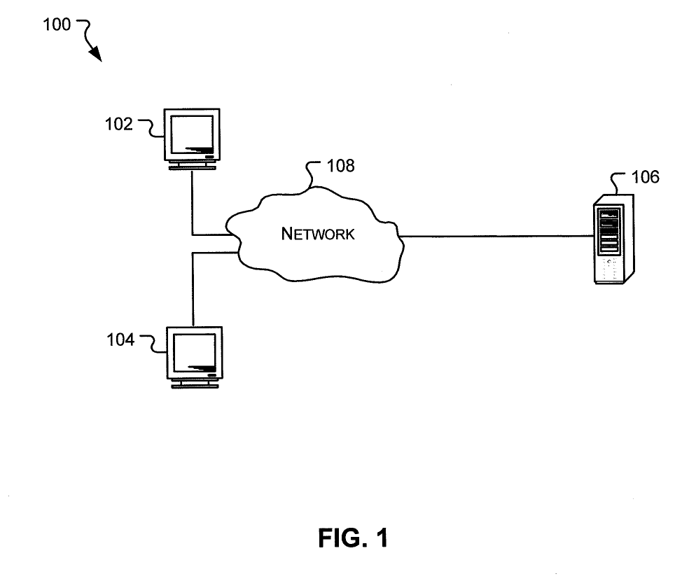

FIG. 1 illustrates a system 100 that may be used to implement some embodiments. System 100 includes clients 102 and 104 and a server 106. Clients 102 and 104 communicate with server 106 through network 108. Server 106 stores information that is accessed by applications on clients 102 and 104. Clients 102 and 104 establish sessions with server 106 to access the information on server 106. Although in FIG. 1 only clients 102 and 104 are shown as communicating with server 106, in other embodiments there may be more than two clients accessing information from server 106.

In embodiments, applications on clients 102 and 104 request file information from a file system, transparent to the application. The file information is retrieved from a file system on server 106. In an embodiment, such file system on server 106 is a remote file system. In another embodiment, the file system on server 106 is a distributed file system. Numerous types of file systems may be used in accordance with embodiments disclosed herein without departing from the spirit and scope of the present disclosure. Further, although not shown, in some embodiments instead of a single server 106, the server may be one of a number of servers that is part of a server cluster, for example. In other embodiments, the server may be one of a number of servers that is not part of a server cluster. The plurality of file servers in such embodiments provides redundancy and high availability of information, e.g., file information, to clients 102 and 104.

In one embodiment, clients 102 and 104 may send a number of file operations to be performed on files stored in the remote file system on server 106. The clients 102 and 104 use a file access protocol to format requests for file operations to be performed on the files. The file access protocol may be any appropriate protocol such as a version of the Network File System (NFS), or the Server Message Block (SMB) protocol. In accordance with some embodiments, the clients may, in addition to sending regular read and write file operations, request offload read and offload write operations, which are token-based operations. As described in greater detail below, the offload file operations allow large amounts of data to be moved by clients 102 and 104 without the need to transfer the actual data across the network to local RAM on either of clients 102 or 104.

To illustrate one embodiment, client 102 may send a request to establish a session with server 106. For example, client 102 may establish a session with server 106 to access a file system stored on server 106 using a version of the Server Message Block (SMB) protocol. The establishment of a session may involve the exchange of a number of negotiate requests and responses transmitted between client 102 and server 106. In versions of the SMB protocol, there are specifically defined negotiate packets that are used to negotiate the exact version of the protocol that will be used during the session, as well as advertise the capabilities of both the client, e.g., 102, and server, e.g., 106, to each other. In one embodiment, the negotiate packets may include an indication that the server 106 can handle token-based file operations, namely offload read and offload write commands. This allows the client to know that it may request the offload file operations from the server if desired.

Continuing with the example above, after the session is established, client 102 can send a message formatted according to the SMB protocol to server 106 to open a file in the file system on server 106. The server can respond with a handle for the file open. Client 102 may then request an offload read operation formatted according to the SMB protocol, requesting file data from the file. In an embodiment, the client requests data from a portion of the file in the offload read operation. The offload read operation request is a token based read operation.

In response to the request from client 102, the server 106 sends a response formatted according to the SMB protocol with a token that represents the file data requested by client 102. In some embodiments, server 106 may be responsible for generating the token and ensuring that the token consistently represents the file data across any requests from other clients, such as client 104 that may request the same file data. In other embodiments, the file server may pass through any requests from clients to an underlying file storage system. In these embodiments, the underlying file storage system is responsible for generating the token that represents the file data requested by client 102. In either embodiment, server 106 will send a response to client 102 with a token. In generating tokens, embodiments provide that a token may be created even where ranges of the source file used to create the token are not contiguous, for example. In such embodiments, the data from such source ranges is logically concatenated into a single logical range of data represented by the token. In some embodiments, implementations may internally associate a token with specific source ranges, in which such source ranges may not be contiguous with each other.

The token represents immutable data, namely the file data requested by the client 102. Accordingly, client 102 may perform other file operations using the token returned by server 106. For example, at a later point in time, client 102 may use the token to write data into another file. In this example, client 102 may request an offload write operation formatted according to the SMB protocol, in which the offload write operation is also a token based file operation. The offload write operation may include the token previously provided to client 102. The offload write operation may request that the file data represented by the token be written into another file on server 106. In response to receiving the request, server 106 will, in an embodiment, then process the request by writing the file data represented by the token into the other file on server 106. In another embodiment, in response to receiving the request, server 106 will first validate the received token, and, if the token is valid, will then write the file data represented by the token into the other file on server 106. As noted above, in those embodiments in which the tokens are generated by the underlying file storage system or lower layer(s), server 106 will merely pass the offload write request through to the underlying file storage system, which will then process the request and write the file data into the other file. Server 106 will then send a response to client 102 indicating whether the offload write was successful. While “file” data is referred to, other embodiments provide for the token to represent any type of data. For example, embodiments provide for a token to have been obtained from any storage container, such as a file, volume, disk, volume snapshot, disk snapshot, blob store, etc. The term “file data” is used herein for purposes of illustration and is not intended to be limiting. Further, while the embodiment discussed above provides for the offload write operation to request that the file data represented by the token be written into another file on server 106, another embodiment provides for the offload write operation to request that a portion of the file data represented by the token be written into another file on server 106.

In addition, while the embodiments discussed above provide for the offload write operation to include the token previously provided to client 102, other embodiments provide for client 102 to use a well-known token as the token with the offload write operation. For example, a well-known token such as the zero token may be used to write data (such as zeros) without any previous corresponding offload read.

In some embodiments, file server 106 may not be able to create a token for all of the file data requested by the client. This may occur, for example, if another client such as client 104 has a lock on some portion of the range of file data requested by the client 102. In these embodiments, server 106 may send a truncated response. That is, a response that includes a token that represents only a portion of the file data requested by client 102. The response, in embodiments, thus indicates that the token represents less than all of the first data requested in the offload read request. In some embodiments, this token may represent a discontinuous data range. However, in other embodiments, the token may represent a continuous range of data, however, it may be less than the file data requested by client 102 in the offload read request. In these embodiments, the server response will include an indication of the portion of the file data that is represented by the token sent in the truncated response.

While some embodiments provide for a truncated offload read response, embodiments of the present disclosure also provide for a truncated offload write. As discussed above, an offload write operation may request that the data represented by the associated token be written into another file on the server, e.g., server 106. In response to receiving the request, server 106 will then process the request by writing the file data represented by the token into the other file on server 106. In embodiments, server 106 is not able to write all of the data represented by the token into the other file. As a result, the offload write may be truncated in embodiments, in which “LengthWritten,” for example, is less than the requested length to write. For example, size restrictions may limit the ability to write all of the data represented by the token into the other file. In another embodiment, a lock on a portion of the file to be written to may prevent the portion of the file from being written to. Processing errors, or other types of errors, may also cause portions of the data represented by the token to not be written into the other file. Further, the token may be partially corrupted or partially invalid, in which server 106 is not able to successfully write the corrupted/invalid portion of the data into the other file. Other reasons may prevent all of the data represented by the token from being written into the other file in accordance with embodiments disclosed herein without departing from the spirit and scope of the present disclosure. In embodiments involving a truncated offload write, a truncated offload write response may be sent from server 106 to client 102, for example, indicating that a portion of the data was not written into the other file. Such indication may occur, in embodiments, through the use of a flag or other indicator, for example. Further, in embodiments, the truncated offload write response indicates how much data was actually written.

The foregoing description is merely one example of how the embodiment shown in FIG. 1 may operate. As described in greater detail below, embodiments may involve different steps or operations. These may be implemented using any appropriate software or hardware component.

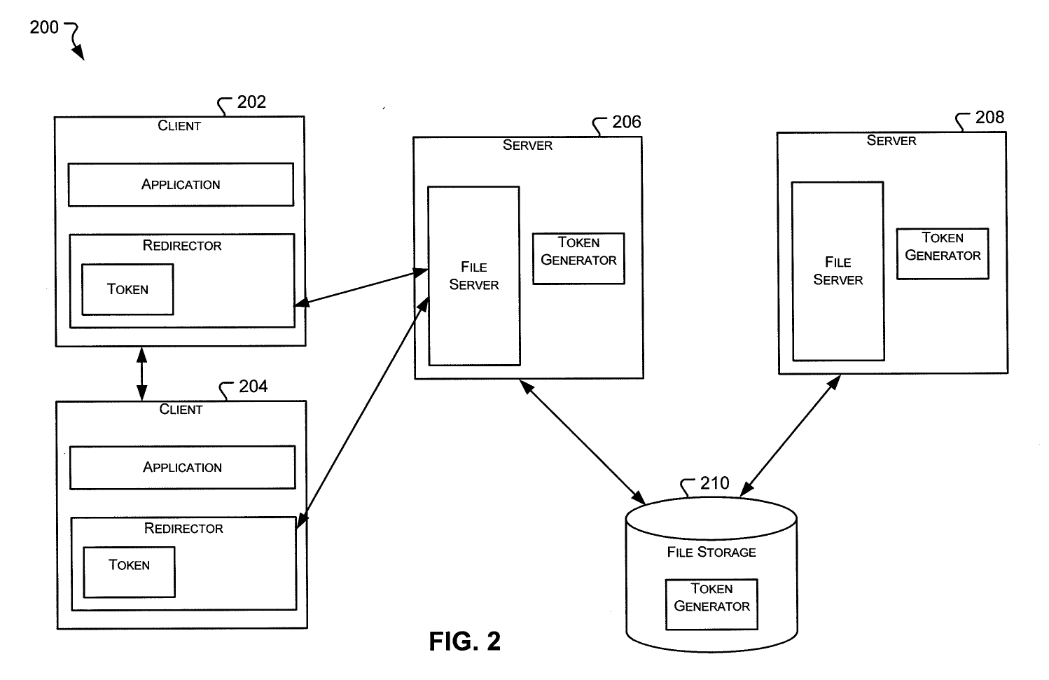

Turning now to FIG. 2, it shows a block diagram of a software environment 200 with client 202, client 204, a server 206, and a server 208. Also shown is file storage 210 where the file information is stored.

As is shown in FIG. 2, client 202 and client 204 each include an application which may request file information. The application may be, for example, a word processing application, a spreadsheet application, a browser application or any other application which requests access to files. In the embodiment shown in FIG. 2, the files are located in a file system stored within file storage 210. While FIG. 2 shows file storage 210 providing shared storage capabilities for servers 206 and 208, according to an embodiment disclosed herein, other embodiments have other storage means. For example, server 206 and server 208 may each have their own storage means, whether detached or attached according to embodiments. In yet further embodiments, server 206 and server 208 may each have their own storage means and have shared storage capabilities through the use of file storage 210. Numerous types of storage may be used in accordance with embodiments disclosed herein without departing from the spirit and scope of the present disclosure. Client 202 and client 204 each further include a redirector which redirects requests for files from the applications to a file server, which provides access to the remote file system. The redirectors communicate with file servers using a file access protocol. In some embodiments, the file access protocol may be a version of the NFS or SMB protocol. For purposes of illustration, FIG. 2 will be described assuming that the redirectors in client 202 and client 204 communicate with file servers using a version of the SMB protocol, such as SMB 2. Embodiments are, however, not limited to the use of an SMB protocol.

Servers 206 and 208 are shown in FIG. 2 as each including a file server. As noted above, the file servers may use a version of the SMB protocol to communicate with the redirectors on client 202 and client 204. Each of servers 206 and 208 also include a token generator module which generates tokens that represent file data. In addition, file storage 210 also includes a token generator module to generate tokens that represent file data.

The use of the SMB protocol to establish a session between a client and a server begins with a redirector, such as the redirector on client 202, sending a negotiate request to a file server such as server 206. The redirector and file server exchange negotiate packets to negotiate the version of SMB that will be used for the session. Additionally, during the negotiation, capabilities may also be exchanged. In one embodiment, server 206 may include a capability flag in a negotiate response packet sent from the file server to the client to indicate to the client that the file server supports the use of offload file operations. In other embodiments, client 202 and server 206 may simply negotiate the version of the SMB protocol understanding that the version includes support for the use of offload file operations. In yet other embodiments, a determination that a version of the protocol supports offload file operations occurs when an offload file operation is attempted. For example, client 202 may request an offload read (or offload write) operation. If server 206 supports offload file operations, server 206 will proceed with processing the request. If server 206 does not support offload file operations, server 206 will send a response to client 202 indicating that the requested offload file operation cannot be performed. For example, in an embodiment, if server 206 does not support offload file operations, server 206 responds to client 202 with an error message and/or flag indicating such.

Once the negotiation is completed, the redirector on the client 202 and the file server 206 establish a session. The client redirector can then send file access requests to the file server. In one embodiment, the redirector on client 202 requests an open on a file. The server 206 provides a response with a handle for the open. Client 202 can then request an offload read operation using the handle. In embodiments, the offload read operation is formatted according to the SMB protocol. In some embodiments, the offload read and offload write operations are sent using the SMB protocol connection by encapsulating the commands within a SMB2 input/output control (IOCTL) request, in the same manner as other file system control commands (FSCTLs). Below is an example of a structure that can be used to request an offload read operation in some embodiments.

typedef struct_FSCTL_OFFLOAD_READ_INPUT {

ULONG Size;
ULONG Flags;
ULONG TokenTimeToLive; // In milliseconds
ULONG Reserved;
ULONGLONG FileOffset;
ULONGLONG CopyLength;

} FSCTL_OFFLOAD_READ_INPUT,
*PFSCTL_OFFLOAD_READ_INPUT;

As indicated above, the structure used by the client to request an offload read operation may include a number of fields. In embodiments, it may include a time to live suggestion for the server. In other words, the field may indicate a suggested lifetime for the token that the server will send. It also includes the file offset and copy length of the file data requested by the client.

In response to the request, the server 206 will send back a response. Below is an example of a structure that can be used to respond to an offload read operation.

typedef struct_FSCTL_OFFLOAD_READ_OUTPUT {

ULONG Size;
ULONG Flags;
ULONGLONG TransferLength;
UCHAR Token[512];

}FSCTL_OFFLOAD_READ_OUTPUT,
*PFSCTL_OFFLOAD_READ_OUTPUT;

As shown above, the response will in embodiments include the token that represents the file data requested by the client 202. The token will also include in embodiments the length of the file data represented by the token.

In some embodiments, the server 206 may respond to the offload read request with a failure or an indication that the read request was processed to a lesser extent. Below are three flags that can be set by the server in an offload read response to indicate additional information to the client.

#define
OFFLOAD_READ_FLAG_ALL_ZERO_BEYOND_CURRENT_RANGE (1)
#define OFFLOAD_READ_FLAG_FILE_TOO_SMALL (2)
#define
OFFLOAD_READ_FLAG_CANNOT_OFFLOAD_BEYOND_CURRENT_RANGE (4)

The second flag listed above indicates that the request failed because the file was too small. There may be situations in which the file data payload for a small file is stored directly in a file record rather than stored in separate clusters. For such files, there is little efficiency to be gained from a correspondingly small offload read, and so rather than handling a small offload read to such a file, the source file system can fail the offload read and the response may include the second flag defined above that indicates that the request failed because the file data is too small. The first flag defined above indicates that the remaining data beyond the transfer length indicated by the offload read response includes all zeros. Finally, the third flag may be used in those situations in which the server determines that offload read requests beyond the transfer length indicated by the offload read response will not succeed. The third flag indicates that the server will be unable to provide a token for data requested by the client beyond the range indicated by the current offload read response. Although not shown, the offload read response may also provide information such as an indication that the returned sub-portion represents non-contiguous data (instead of just a contiguous byte count from offset 0). The offload read response may also contain, in embodiments, a hint as to the next subsequent source offset for which an offload read may succeed. While the three flags provided above include numeric values for the flags, these numeric values are offered for purposes of illustration. Other numeric values or values in general may be used according to embodiments without departing from the spirit and scope of the present disclosure.

Once the client 202 has received a token, either by a previous offload read request or by some other means, the client 202 may issue an offload write request to server 206. Below is an example of a structure that may be used in embodiments for a client to send an offload write request.

typedef struct_FSCTL_OFFLOAD_WRITE_INPUT {

ULONG Size;
ULONG Flags;
ULONGLONG FileOffset;
ULONGLONG CopyLength;
ULONGLONG TransferOffset;
UCHAR Token[512];

}FSCTL_OFFLOAD_WRITE_INPUT,
*PFSCTL_OFFLOAD_WRITE_INPUT;

As indicated in the example above, the structure of the offload write includes the offset of the destination file to copy to, the length of the data to copy, as well as an offset into the data represented by the token of where to copy from. Also included is the token, which may have been received from the server or by other means.

In response to the offload write request, server 206 issues an offload write response. An example of a structure for use by server 206 in an offload write response is provided below.

typedef struct_FSCTL_OFFLOAD_WRITE_OUTPUT {

ULONG Size;
ULONG Flags;
ULONGLONG LengthWritten;

}FSCTL_OFFLOAD_WRITE_OUTPUT,
*PFSCTL_OFFLOAD_WRITE_OUTPUT;

In some embodiments, the server 206 may respond to the offload write request with a failure. For example, an offload write operation may fail where the requested file is a small file, e.g., below a defined size threshold. Below is an example of a flag that can be set by the server in an offload write response to indicate that the request was failed because the file information was too small. As previously noted, small files may store their data differently than larger files, and it can be more appropriate to fail an offload request issued to such a small file since there is very little efficiency gained from using a token instead of the actual file data. In another embodiment, an offload write operation may fail where the link between the recipient of the offload write and the data source is slow. In such an embodiment, the file system may perform a link status check in determining whether to respond to an offload write operation. In such example cases, the server 206 may fail the offload write request. In yet other embodiments, the server 206 may fail the request due to an invalid token. For example, a token may be invalid where it is expired. Where the server fails the request due to an invalid/expired token, the server 206 may respond to the offload write request with a failure, in which a flag (as shown below as an example flag) may be set by the server in the offload write response to indicate that the request was failed because the token was invalid or expired, for example. This type of flag may act as a hint to the client that a simple retry of the write operation will not work and that it must re-read to generate a new token (i.e., the failure was not due to a temporary slowness of the link but, rather, because the token was invalid, for example). In an alternative embodiment, a specific status may be returned to indicate that the given token is no longer valid. Thus, embodiments provide for a return status to be used to indicate that the token is no longer valid, while other embodiments provide for a flag to be used to provide such indication. Yet other embodiments provide for both a flag and a return status to be used to provide such indication. For example, on truncations due to token expiration, for example, instead of an error code, an operation may return success with the truncated value to the caller of the FSCTL along with the flag, e.g., OFFLOAD_WRITE_FLAG_TOKEN_INVALID, to indicate that there is no use in retrying the rest of the offload write using the same token(s). Numerous other types of conditions may lead to offload write failure in accordance with embodiments disclosed herein without departing from the spirit and scope of the present disclosure.

#define OFFLOAD_WRITE_FLAG_FILE_TOO_SMALL (1)
#define OFFLOAD_WRITE_FLAG_TOKEN_INVALID (2)

While the flags provided above include numeric values for the flags, these numeric values are offered for purposes of illustration. Other numeric values or values in general may be used according to embodiments without departing from the spirit and scope of the present disclosure.

Further, some embodiments provide for the offload write to be truncated, as discussed above, in which LengthWritten, for example, is less than the requested length to write. In such embodiments, the server responds to the offload write request with a truncated offload write response, indicating that only a portion of the data requested to be written was actually written.

In embodiments, the tokens used in the offload read and write operations are formatted consistent with a standard. For example, the Small Computer System Interface (SCSI) standard may provide some definition of token formats that may be used, according to an embodiment. Numerous types of standards, including high-speed computer interface specifications and/or standards, among others, may be used in accordance with embodiments disclosed herein without departing from the spirit and scope of the present disclosure. The SCSI standard is offered by way of example. The use of a standard format allows the tokens to be interoperable with other servers using different data access protocols.

Server 206 may in embodiments recognize and use well-known token values specified in an offload write command, even when there was no prior offload read (from the server or from any source). For example, server 206 may return a well-known token representing a range containing zeroes. Client 202 will interpret this as indicating that the underlying ranges of the source file are zero, and that the data associated with the token are all zeroes. In another embodiment, a zero token may be returned in response to an offload read request, such as where the file system would return zeros if read normally. Such a situation may arise where a sparse range of a file is read, for example. In further embodiments, the server 206 may also accept other well-known tokens such as the deallocated token.

In those embodiments in which the token generator on server 206 is used to generate tokens, the token returned from the offload read request is usable by any client which requests information from server 206. Thus, client 204 may receive a token from client 202 and can use that token for requesting offload write operations from server 206. In embodiments where tokens are passed between clients, the clients may pass such tokens via any protocol or transport of their choice. The mode of passing the tokens amongst clients has no bearing on the tokens themselves. The tokens are therefore usable across different connections with server 206 which may be established by different clients. In this manner, the server 206 can service offload read requests and some offload write requests regardless of whether file storage 210 supports offload read and write operations. The token provided by the client in an offload write to the server 206 need not have been obtained from a file to which the client has a currently-open handle, and need not have been obtained from a file to which the client has access. The client may obtain the token indirectly via another client which did have access to the file(s) from which the token was obtained at least at the time at which the token was obtained. A token obtained by the client via offload read from one share, e.g., file share, via one connection may be successfully used in an offload write issued by the client to a different share or different connection.

In embodiments, the tokens may be usable across a number of servers. That is, a token may be used on a server even if it did not come from that server originally. In other words, where a token is generated at server 206, server 208, or file storage 210, such token can be used on any server that decides to honor the token. For example, in the embodiment above, the offload read request sent by client 202 may be passed to file storage 210, which generates the token for the offload read request. If, at a later time, client 202 connects to server 208 it can use the token previously provided by its connection to server 206 to perform other operations such as an offload write operation. In this example, server 208 will pass through any offload write operation to file storage 210, which originally created the token. In this way, tokens can be usable across a number of servers. This embodiment may be used in situations, for example, in which a server cluster using shared storage is used to provide file services to clients.

As may be appreciated, the above description of environment 200 is not intended to limit the embodiments described herein. FIG. 2 and its description are merely intended to illustrate implementation of some embodiments. In other embodiments, the offload operations may involve one or more files and one or more tokens. Thus, embodiments are not limited to what is shown and described in FIG. 2. For example, the offload read may provide for reading multiple segments of a single file or multiple files with the offload read response including a single token or multiple tokens. Similarly, in some embodiments, offload write operations may identify one or more tokens associated with one or more files.

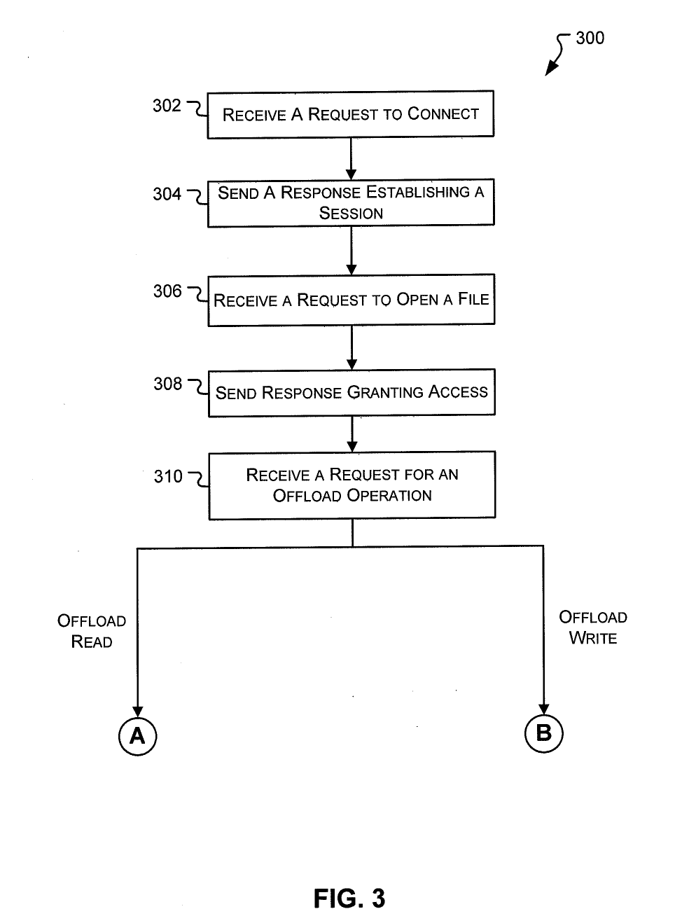

FIGS. 3, 4, 5, and 6 illustrate operational flows 300 and 400 according to embodiments. Operational flows 300 and 400 may be performed in any suitable computing environment. For example, the operational flows may be executed by systems and environments such as illustrated in FIGS. 1 and 2. Therefore, the description of operational flows 300 and 400 may refer to at least one of the components of FIGS. 1 and 2. However, any such reference to components of FIGS. 1 and 2 is for descriptive purposes only, and it is to be understood that the implementations of FIGS. 1 and 2 are non-limiting environments for operational flows 300 and 400.

Furthermore, although operational flows 300 and 400 are illustrated and described sequentially in a particular order, in other embodiments, the operations may be performed in different orders, multiple times, and/or in parallel. Further, one or more operations may be omitted or combined in some embodiments.

In embodiments, flow 300 illustrated in FIG. 3 may be performed, at least in part, by a file server that is running on a server, e.g., server 206 (FIG. 2). Flow 300 begins at operation 302 where a request to connect to a file server is received. The request received at operation 302 is a request to establish a session with the file server in order to access file information stored on a remote file system accessible through the file server. The request may be sent by a client, e.g., clients 202 and 204 (FIG. 2). After operation 302, flow 300 passes to operation 304 where a response is sent indicating that a session has been established. In some embodiments, the request and response sent at operations 302 and 304 may be part of a number of messages that are exchanged between a client and a server to negotiate a session. The exchange of messages may include an exchange of capabilities, including the capability of the file server to service offload file operations.

Operational flow 300 passes from operation 304 to operation 306 where a second request is received to open a file. The request is sent by the client in order to access information within a file. From operation 306, flow passes to operation 308 where a response is sent to the client granting access to the file. The response may include a file identifier that is provided by the file server in the response.

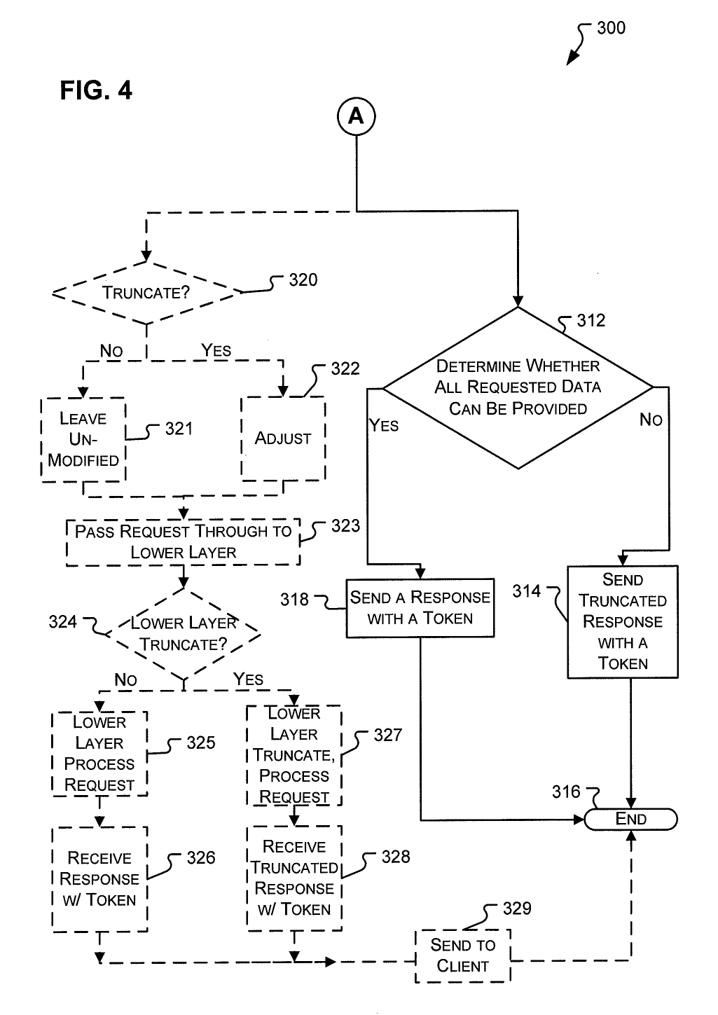

Flow 300 then passes to operation 310, where a request is received for an offload operation. The offload operation may be an offload read operation which requests file data which is represented by a token or an offload write operation which includes a token representing file data to be written to a destination file. If the operation is an offload read operation, flow passes to A, which is continued in FIG. 4.

As shown in FIG. 4, flow 300 passes to decision 312 where a determination is made whether the data requested in the offload read operation can all be represented by a token. This decision 312 may involve, in embodiments, a number of different determinations. For example, a determination may be made as to whether any portion of the data being requested in the offload read operation is locked for exclusive use by another client. In these situations, the server may be unable to provide a token that represents all of the requested data. If at decision 312 a determination is made that it is not possible for all of the requested data to be represented by a token, flow passes NO to operation 314, where a truncated response with a token is sent. The truncated response indicates that the token that is being provided in the response does not represent all of the data requested in the offload read request. The response may also indicate what range of data is represented by the token in the response. After operation 314, flow ends at 316.

If a determination is made at decision 312 that all of the requested data can be represented by a token, a response is sent at operation 318 that includes a token that represents all of the file data requested in the offload read request. Flow 300 then ends at 316.

In some embodiments, the server may not be the provider of tokens. In these embodiments, the alternative operations shown in dashed lines may be performed instead of decision 312, operation 314, and/or operation 318. The operations in dashed lines are performed in those embodiments in which the generation of tokens occurs at a lower layer, e.g., the underlying file storage level(s). In these embodiments, flow 300 will pass to query 320 instead of decision 312. At query 320, it is determined whether the offload read operation will be truncated. If the offload read will be truncated, in which an adjustment to the length of the data requested will be performed, for example, process 300 proceeds YES to adjust or truncate 322. If the server will not make any adjustments, process 300 proceeds NO to leave the request un-modified 321. Next, process 300 proceeds to operation 323 where the offload read request is passed from the server to a lower layer, such as the file storage component or other module that is responsible for generating the tokens.

After operation 323, flow 300 passes to query 324 where it is determined whether the file storage (or other component responsible for generating the tokens) will perform a truncated read operation. If no truncation occurs, process 300 proceeds NO to process request 325 by the lower layer. The response with a token is then received 326 by the server, in which the response received at operation 326 includes a token(s) that represents at least a portion of the file data requested in the offload read operation. The tokens may be formatted according to any appropriate format used by the file storage. In one embodiment, the tokens are formatted according to a predefined SCSI format. The response with a token(s) is then sent by the server to the client 329, according to an embodiment. In another embodiment, the response with a token(s) is sent directly from the file storage, or other lower layer, to the client, for example.

Returning to query 324, as discussed above, it is determined whether the file storage or other component responsible for generating the tokens will provide a response including all of the data requested. For example, in an embodiment, the file storage may not be able to provide all of the data requested in the offload read request. As discussed above, numerous reasons may lead to a truncated offload read response, including a lock on the storage container preventing a full read, etc. If the file storage provides only a portion of the data requested, process 300 proceeds YES to operation 327, in which the request is processed and a truncated response is provided by the lower layer, e.g., file storage. In an embodiment, a truncated response with token is then received 328 at the server to send 329 to the client. In other embodiments, the response with token is passed directly from the file storage or other component responsible for generating the tokens to the client. In embodiments, the received truncated response 328 indicates that the request was truncated by one or more layers. For example, the response indicates that the token represents less than all of the data requested in the offload read request. In other embodiments, the truncated response 328 provides no indication that the request was truncated. Flow 300 then ends at operation 316. In another embodiment (not shown), the server may determine to further truncate the data in the response upon receiving it from the file storage and even if it determines that the data has already been truncated by the file storage. In such embodiment, such truncation may occur after operations 326 and 328 and before passing the truncated response with token to the client operation 329. As can be appreciated, the operations 320-329 are performed when the server is merely acting as a pass-through to a lower-level token provider. In the embodiment shown in FIG. 4, the token provider is the file storage system. In some embodiments, the file storage system may in turn pass through the offload request to a further lower-level token provider. In embodiments, any layer can truncate, before or after sending the request down to the layer below. For example, embodiments provide for the server to pass the request through to the lower layer, e.g., file storage, receive a response from the lower layer, and then determine whether the server will perform further truncation before sending the response with a token(s) to the client. However, it may be more efficient in some embodiments to truncate the request prior to sending it to the layer(s) below. As discussed, flow 300 is merely an example of an operational flow that may be performed in accordance with embodiments. Embodiments are not limited to the specific description provided with respect to FIGS. 3-5 and may include additional operations. For example, operational steps depicted may be combined into other steps and/or rearranged. Further, fewer or additional steps may be used, for example.

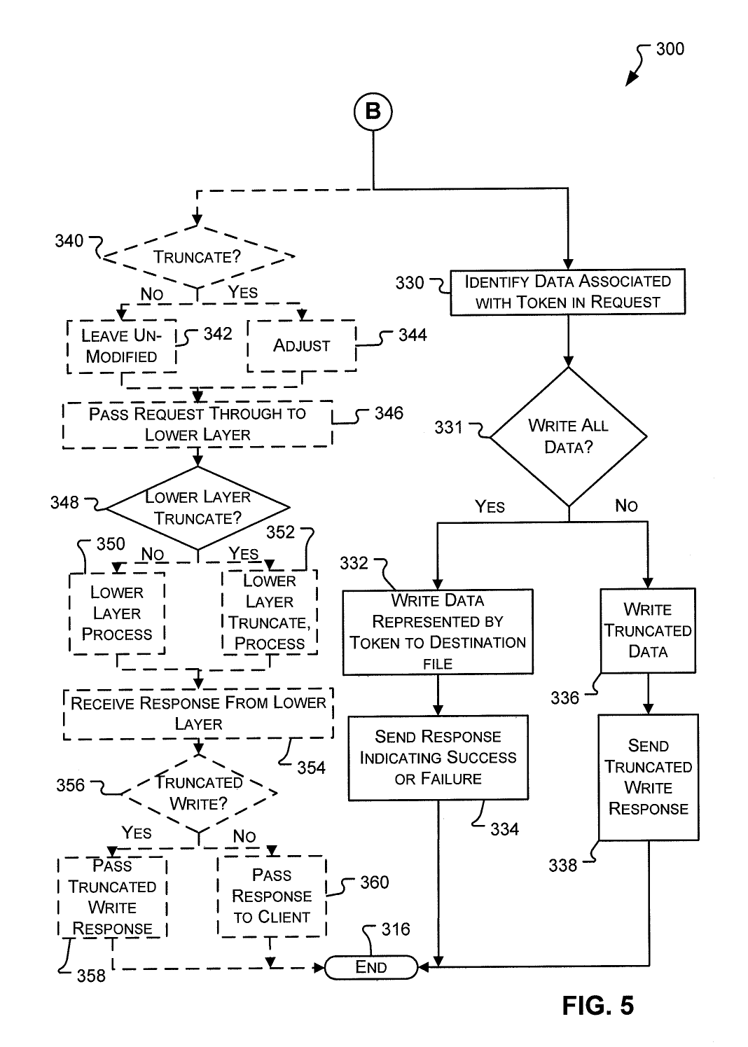

Referring again to FIG. 3, if at operation 310 the operation is an offload write operation, flow passes to B, which is continued in FIG. 5. As can be appreciated, the offload write operation will include a token that represents data. A token may be obtained from numerous types of storage containers in accordance with embodiments disclosed herein without departing from the spirit and scope of the present disclosure. For example, a token may be obtained from a file, volume, disk, volume snapshot, disk snapshot, blob store, etc. In an embodiment, a token is created by copying data from the source file into the token. In a further embodiment, a token is created by copying data from the source file into a holding area associated with the token. The created token is thus independent from the source file and is logically its own read-only container of data. As shown in FIG. 5, flow passes from operation 310 to operation 330 where the data associated with the token in the offload write operation is identified.

After the data is identified at operation 330, flow 300 passes to query 331 where it is determined whether all requested data can be written to the destination file, for example, by the server. If all requested data can be written, process 300 proceeds YES to write the data represented by the token to the destination file 332. That is, the requested portion of the data represented by the token is written to the specific location requested in the offload write request. A response indicating success or failure and, in some embodiments, the amount of data written to the destination file, is sent to the client at operation 334. Flow 300 then ends at 316. On the other hand, if all of the requested data cannot be written to the destination file, for example, process 300 proceeds NO to write truncated data operation 336, in which a portion of the requested data is written. A truncated write response indicating that a portion of the requested data was written is then sent to the client in operation 338. Flow 300 then ends at 316.

As noted above, in some embodiments, the server may not be the provider of tokens. In these embodiments, the alternative operations shown in dashed lines in FIG. 5 may be performed instead of operations 330-338. The operations in dashed lines are performed in those embodiments in which the generation of tokens occurs at a lower layer, e.g., the file storage level or below. In these embodiments, flow 300 will pass to query 340 instead of operation 330. At query 340, it is determined whether the offload write will be truncated at the server before passing to the lower layer, e.g., underlying file storage. If the offload write will be truncated, process 300 proceeds YES to adjust or truncate 344. If the server will not make any adjustments, flow 300 proceeds NO to leave the offload write request unmodified 342. Next, process 300 proceeds to operation 346 where the offload write request (with token) is passed from the server to a lower layer, such as the file storage component or other module that is responsible for handling the offload write request.

After passing the offload write request to the lower layer(s) 346, flow 300 proceeds to query 348 where it is determined whether the lower layer, e.g., file storage, will perform a truncated write operation. If no truncation occurs, process 300 passes NO to operation 350, in which the lower layer processes the write request, including, for example, identifying the data associated with the token in the request and writing the data represented by the token to the destination file. If the lower layer performs a truncated write, process 300 proceeds YES to lower layer truncate and process operation 352, in which a portion of the data requested is written to the destination file, for example. Following the processing of the offload write request by the lower layer(s), the offload write response is received 354 at the server from the lower layer indicating, in embodiments, whether the data represented by the token was successfully written to the destination file as well as how much data was written. In other embodiments, the offload write response is passed directly from the file storage or other component responsible for handling the offload write request to the client.

Returning to FIG. 5 where the offload write response is received 354 at the server in accordance with embodiments of the present disclosure, query 356 next determines whether all of the data was written to the destination or if the write was truncated. If the write was truncated, in which a portion of the requested data was written to the destination, process 300 proceeds YES to pass truncated write response 358 to the client. Flow 300 then ends at 316. Returning to query 356, if it is determined at query 356 that all of the requested data was written to the destination, process 300 proceeds NO to operation 360, in which the response from the underlying file storage system is passed to the client. Flow 300 then ends at 316.

Thus, in embodiments, the server itself may truncate the write even where the request is passed through to the lower layer, such as the file storage. For example, the server may truncate the write where the time for processing the write request exceeds a predetermined threshold, according to embodiments. In embodiments, the server truncates the write before passing the request through to the lower layer. For example, the truncation can happen before sending the offload write request to file storage. In other embodiments, the server truncates the write after processing by the lower layer, e.g., file storage. As discussed, flow 300 is merely an example of an operational flow that may be performed in accordance with embodiments. Embodiments are not limited to the specific description provided above with respect to FIGS. 3-5 and may include additional operations. For example, operational steps depicted may be combined into other steps and/or rearranged. Further, fewer or additional steps may be used, for example.

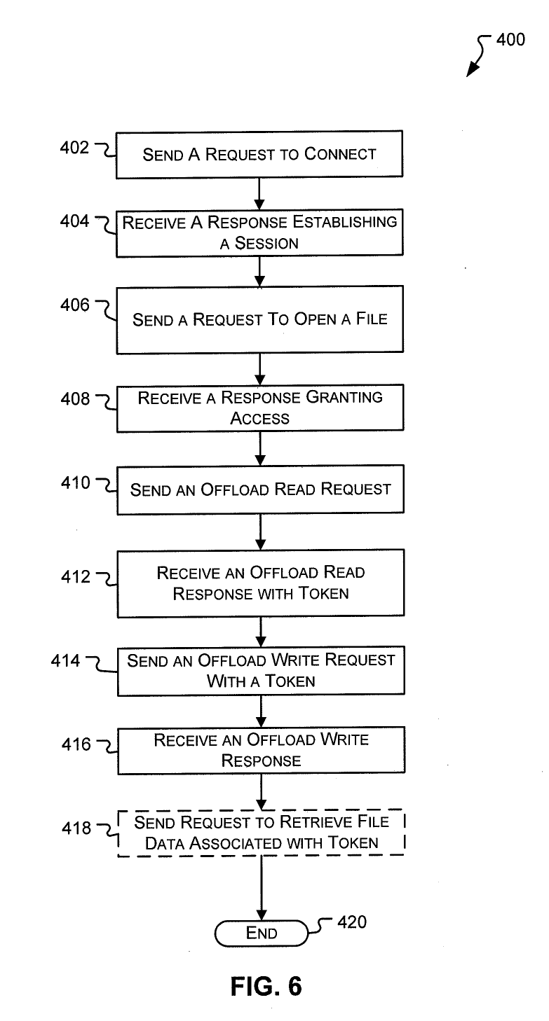

Turning to FIG. 6, operational flow 400 illustrates steps for requesting offload file operations. In embodiments, flow 400 may be performed by redirectors on clients, such as clients 202 and 204 (FIG. 2), that are communicating with a file server to access files in a file system. The client communicates, in embodiments, with the file server using a file access protocol, such as a version of the SMB protocol or a version of NFS.

Flow 400 begins at operation 402 where a request to connect to the file server is sent. The request sent at operation 402 is a request to establish a session with the file server in order to access file information stored on a file system accessible through the file server. The request may be sent to a file server on a server, e.g., server 206 (FIG. 2). The request is formatted according to a file access protocol such as a version of SMB or NFS.

After operation 402, flow 400 passes to operation 404 where a response is received indicating that a session has been established. In some embodiments, operations 402 and 404 may be part of a number of messages that are exchanged between a client and a server to negotiate a session. The exchange of messages may include an exchange of capabilities including the capability of the file server to service offload operations.

Operational flow passes from operation 404 to operation 406 where a request is sent to open a file. Flow 400 passes from operation 406 to operation 408 where a response is received granting access to the file. From operation 408, flow passes to operation 410 where the client will send an offload read request. The offload read request indicates a portion of file data being requested. The offload read request also inherently requests that the data be represented by a token that is sent in response to the offload read request. At operation 412, an offload read response with a token is received.

In embodiments, the client that sends the offload read request at operation 410 may have some limits as to what data it may ask for in the read request. For example, in embodiments, if the client has cached some data locally it will flush any cached “dirty” data before sending its read request. Failure to flush the cached dirty data to the server prior to sending the offload read can lead to the offload read providing a token which represents stale data. In some embodiments, the client may truncate the offload read itself. In other words, it may not request the full range of file data and thereby exclude dirty cached data.

Following operation 412, the client may send an offload write request at operation 414. Although flow 400 shows that operation 414 immediately follows operation 412, it can be understood that this is merely for illustrative purposes. In other embodiments, if the client performing flow 400 receives a token representing data from some other means, then the offload write request sent at operation 414 may be performed before any offload read requests such as the request sent at operation 410.

In embodiments, the client that sends the offload write request at operation 414 may also have some limits as to what data it may send in the offload write request. If an offload write were allowed to write token data to a destination offset which has cached dirty data, the cached dirty data would later erroneously overwrite the data written by the offload write when the cached dirty data is written back to storage. A client sending an offload write may avoid sending the write request for any offset for which the client is holding cached dirty data. The client may truncate the offload write itself, or the client may discard the cached dirty data which overlaps the offload write destination offsets, or the client may fail the offload write, according to embodiments.

After the offload write request is sent at operation 414, flow 400 passes to operation 416 where a response to the offload write request is received. The response may indicate whether the data associated with the token sent in the offload write request was successfully written to a destination file. In those embodiments in which the data may have been partially written, the response received at operation 416 will note the portion of the data that was successfully written and indicate that not all of the data was written into the destination file.

Operation 418 shown in dashed lines is performed in some embodiments at any time during execution of flow 400. In the embodiment shown in FIG. 6, operation 418 is shown after operation 416 but embodiments are not necessarily limited to this order. Operation 418 is sent in those embodiments in which a client performing flow 400 requires the actual data associated with the token. That is, the client may be in possession of a token that it received by sending an offload read request or by some other means. However, the client may need the actual data associated with the token to, for example, provide the data to an application that is requesting the actual data. In these embodiments, operation 418 may send a request to retrieve a portion of the data associated with the token. The client will send the request to retrieve data to a server that can provide the actual data. In response, the client will receive the actual data and can provide that data to the application requesting the actual data. This is merely one additional operation that may be performed by some clients in some embodiments. Flow 400 ends at 420.

As noted above, flows 300 and 400 are merely some examples of operational flows that may be performed in accordance with embodiments. Embodiments are not limited to the specific description provided above with respect to FIGS. 3-6 and may include additional operations. Further, operational steps depicted may be combined into other steps and/or rearranged. Further, fewer or additional steps may be used, for example.

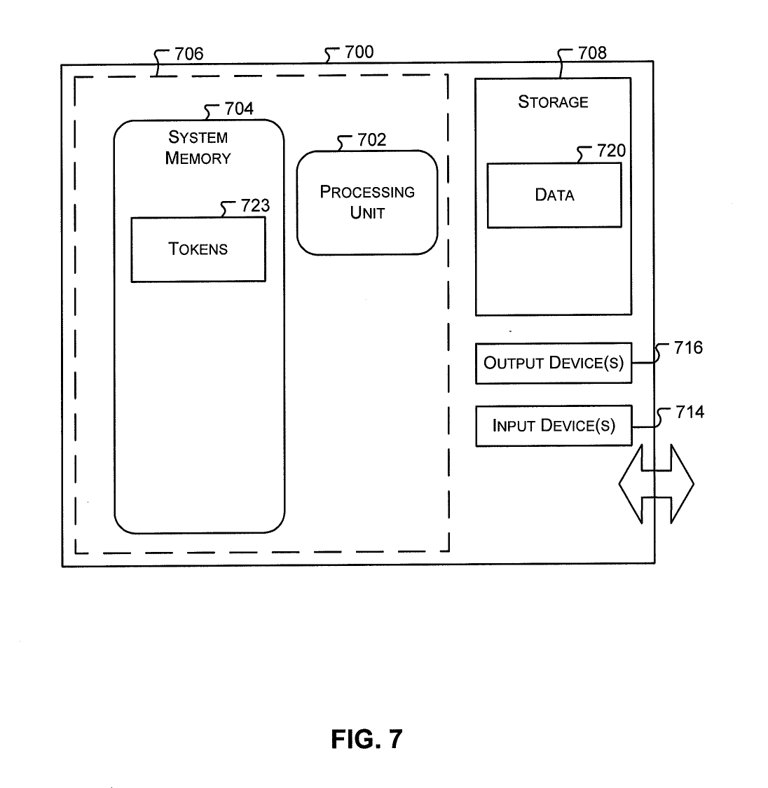

FIG. 7 illustrates a general computer system 700, which can be used to implement the embodiments described herein. The computer system 700 is only one example of a computing environment and is not intended to suggest any limitation as to the scope of use or functionality of the computer and network architectures. Neither should the computer system 700 be interpreted as having any dependency or requirement relating to any one or combination of components illustrated in the example computer system 700. In embodiments, system 700 may be used as a client and/or server described above with respect to FIG. 1.

In its most basic configuration, system 700 typically includes at least one processing unit 702 and memory 704. Depending on the exact configuration and type of computing device, memory 704 may be volatile (such as RAM), non-volatile (such as ROM, flash memory, etc.) or some combination. This most basic configuration is illustrated in FIG. 7 by dashed line 706. System memory 704 stores data such as tokens 723, which represent data 720 that may be stored in a file storage system with storage such as storage 708.

The term computer readable media as used herein may include computer storage media. Computer storage media may include volatile and nonvolatile, removable and non-removable media implemented in any method or technology for storage of information, such as computer readable instructions, data structures, program modules, or other data. System memory 704, removable storage, and non-removable storage 708 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. Computing device 700 may also have input device(s) 714 such as a keyboard, a mouse, a pen, a sound input device, a touch input device, etc. Output device(s) 716 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Reference has been made throughout this specification to “one embodiment” or “an embodiment,” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that the embodiments may be practiced without one or more of the specific details, or with other methods, resources, materials, etc. In other instances, well known structures, resources, or operations have not been shown or described in detail merely to avoid obscuring aspects of the embodiments.

While example embodiments and applications have been illustrated and described, it is to be understood that the embodiments are not limited to the precise configuration and resources described above. Various modifications, changes, and variations apparent to those skilled in the art may be made in the arrangement, operation, and details of the methods and systems disclosed herein without departing from the scope of the claimed embodiments.

We claim:

1. A computer implemented method of providing token based file operations, the method comprising:
receiving at a file server a first request to connect to the file server to access information in a file system;
sending a first response from the file server, the response establishing a session with a client for allowing access to the information in the file system;
receiving at the file server a second request to open a file in the file system to access file information from the file;
in response to receiving the second request, the file server sending a second response to the client granting access to the file;
receiving at the file server a third request for an offload read of first data from a portion of the file, the third request being formatted according to a file access protocol; and
in response to receiving the third request, the file server sending a third response with a token representing the first data, wherein the first data is logically read from the portion of the file, and wherein the third response is formatted according to the file access protocol.

2. The method of claim 1, wherein the file access protocol is a version of the Server Message Block (SMB) protocol.

3. The method of claim 1, wherein the token is generated by the file server.

4. The method of claim 1, wherein the token is generated by an underlying file storage system.

5. The method of claim 1, wherein the third response includes a response indicating that the token represents less than all of the first data requested in the third request.

6. The method of claim 1, wherein the third request indicates first data to be read from the file and second data to be read from the file, and the third response includes the token representing the first data and a second token representing the second data.

7. The method of claim 1, wherein the third request indicates a first portion of a first file and a second portion of a second file and the third response includes the token representing first data logically read from the first portion of the first file and a second token representing second data logically read from the second portion of the second file.

8. The method of claim 1, further comprising:
receiving at the file server a fourth request for an offload write of a requested portion of the first data to a second file, the fourth request including the token and being formatted according to the file access protocol; and
in response to receiving the fourth request, the file server:
writing the requested portion of the first data to the second file; and
sending a fourth response indicating the requested portion of the first data was written to the second file, the fourth response being formatted according to the file access protocol.

9. The method of claim 1, further comprising:
receiving at the file server a fourth request for an offload write of a requested portion of the first data to a second file, the fourth request including the token and being formatted according to the file access protocol; and
in response to receiving the fourth request, the file server:
writing a first portion of the requested portion of the first data to the second file, wherein the first portion of the requested portion is less than all of the requested portion of the first data; and
sending a fourth response indicating the first portion of the requested portion of the first data was written to the second file, the fourth response being formatted according to the file access protocol.

10. The method of claim 9, wherein the third request is received from the client and the fourth request is received from a second client different from the client.

11. The method of claim 2, wherein the third request is a

12. The method of claim 9, wherein the file access protocol is a version of the Server Message Block (SMB) protocol, and wherein the fourth request is a FSCTL_OFFLOAD_WRITE request.

13. The method of claim 1, wherein the token is formatted according to a Small Computer System Interface (SCSI) standard.

14. A computer readable storage medium comprising computer executable instructions that when executed by a processor perform a method of requesting token based file operations, the method comprising:
sending by a client a first request to connect to a file server to access information in a file system;
receiving a first response, the response establishing a session with the client for allowing access to the file information;
sending a second request to open a file in the file system;
receiving a second response granting access to the file;
sending a third request for an offload write of a first portion of data represented by a token to a file, the third request being formatted according to a version of the Server Message Block (SMB) protocol and including the token representing the data; and
receiving a response.

15. The computer readable storage medium of claim 14, wherein the token was generated by the server.

16. The computer readable storage medium of claim 14, wherein the response indicates that a second portion of the data was successfully written to the file, and wherein the second portion represents less than all of the data in the first portion.

17. The computer readable storage medium of claim 14, further comprising:
sending a fourth request for an offload read of second data from a portion of a second file, the fourth request being formatted according to the version of the SMB protocol; and
receiving a fourth response with a token representing the second data, the fourth response being formatted according to the version of the SMB protocol.

18. A system for allowing token based file operations, the system comprising:
at least one server comprising:
at least one processor configured to execute computer executable instructions;
at least one computer readable storage media storing the computer executable instructions that when executed by the at least one processor provide:
a file server configured to:
receive a request for an offload read of data from a portion of a file, the request being formatted according to a version of the Server Message Block (SMB) protocol; and
in response to receiving the request, the file server sending a response with a token representing the data, the response being formatted according to the version of the SMB protocol.

19. The system of claim 18, wherein the system further comprises:
at least one client, comprising:
at least one processor configured to execute computer executable instructions;
at least one computer readable storage media storing the computer executable instructions that when executed by the at least one processor:
sends the request for the offload read of data from the portion of the file; and
receives the response with the token representing the data.

20. The system of claim 19, wherein the computer readable storage media stores computer executable instructions that when executed by the at least one processor:
sends an offload write request with the token to write a portion of the data to a second file.
